(19) United States
(12) Patent Application Publication
(10) Pub. No.: US 2024/0375519 A1
(43) Pub. Date: Nov. 14, 2024

(54) DISTURBANCE OBSERVER-BASED ELECTRIC VEHICLE CONTROL METHOD DURING DOWNHILL MOTION

(71) Applicants: Hyundai Motor Company, Seoul (KR); Kia Corporation, Seoul (KR)

(72) Inventors: Heeseong Kim, Ann Arbor, MI (US); Justin Holmer, Ann Arbor, MI (US); Brian Link, Superior Township, MI (US); Jason Lee, Superior Township, MI (US)

(21) Appl. No.: 18/195,740

(22) Filed: May 10, 2023

(51) Int. Cl. B60L 7/18; B60L 15/20

(52) U.S. Cl. CPC B60L 7/18; B60L 15/2027; B60L 2240/12; B60L 2240/461; B60L 2240/642; B60L 2250/26; B60L 2250/28

(57) ABSTRACT

Systems and methods for automatically applying braking during downhill motion and performing regenerative braking are provided. The method may comprise determining a state of an acceleration pedal and a braking pedal of a vehicle, when the state of the acceleration and braking pedals is off, setting a set velocity of the vehicle to be equal to a current velocity of the vehicle, determining whether a value of the current velocity minus the set velocity is greater than a threshold velocity of the vehicle, when the value of the current velocity minus the set velocity is greater than the threshold velocity, setting a target velocity of the vehicle equal to a sum of the set velocity and the threshold velocity, and performing, using a brake controller, regenerative braking on the vehicle using a disturbance observer (DOB) structure and a feedback controller to maintain the target velocity.

### BACKGROUND

### Technical Field

Embodiments of the present disclosure relate to systems and methods for performing disturbance observer-based control of electric vehicles during downhill motion.

### Background

Gravity plays a roll in the acceleration and deceleration of vehicles as they move on driving surfaces. For example, when a vehicle is traveling uphill, without the application of additional engine force, the vehicle will slow down as it travels upward. Similarly, when a vehicle is traveling downhill, absent sufficient friction (e.g., the application of brakes), the vehicle will accelerate as it travels downhill.

Without controlling the speed of the vehicle during downhill motion, a vehicle will accelerate unnecessarily. This unnecessary acceleration, due to gravity during downhill motion, requires the attention of a driver to control a speed of the vehicle.

For at least these reasons, systems and methods for automatically controlling electric vehicle speed during downhill motion, improving driver experiences, is needed.

### SUMMARY

According to an object of the present disclosure, a method for automatically applying braking during downhill motion and performing regenerative braking is provided The method may comprise a) determining a state of an acceleration pedal of a vehicle and a state of a braking pedal of the vehicle; b) when the state of the acceleration pedal is off and the state of the braking pedal is off, setting, using a processor, a set velocity of the vehicle to be equal to a current velocity of the vehicle, c) determining, using the processor, whether a value of the current velocity of the vehicle minus the set velocity of the vehicle is greater than a threshold velocity of the vehicle, d) when the value of the current velocity of the vehicle minus the set velocity of the vehicle is greater than the threshold velocity of the vehicle, setting, using the processor, a target velocity of the vehicle equal to a sum of the set velocity of the vehicle and the threshold velocity of the vehicle, and e) performing, using a brake controller, regenerative braking on the vehicle using a disturbance observer (DOB) structure and a feedback controller to maintain the target velocity of the vehicle.

According to an exemplary embodiment, the determining the state of the acceleration pedal and the state of the braking pedal may comprise at least one of the following: receiving, from an acceleration pedal position sensor, the state of the acceleration pedal; and receiving, from a braking pedal position sensor, the state of the braking pedal.

According to an exemplary embodiment, the performing regenerative braking on the vehicle using the DOB structure and a feedback controller may comprises, using a regenerative braking torque calculator, calculating a regenerative braking torque, and applying the regenerative braking torque on the vehicle.

According to an exemplary embodiment, the performing regenerative braking on the vehicle using the DOB structure and a feedback controller may comprises monitoring, using one or more wheel speed sensors, a wheel speed of one or more wheels of the vehicle.

According to an exemplary embodiment, the method may further comprise, when the value of the current velocity of the vehicle minus the set velocity of the vehicle is not greater than the threshold velocity of the vehicle, performing, using the brake controller, regenerative braking on the vehicle using the DOB structure to maintain a velocity of the vehicle.

According to an exemplary embodiment, the performing regenerative braking on the vehicle using the DOB structure may comprise, using a regenerative braking torque calculator, calculating a regenerative braking torque, and applying, using the brake controller, the regenerative braking torque on the vehicle.

According to an exemplary embodiment, the performing regenerative braking on the vehicle using the DOB structure may comprise monitoring, using one or more wheel speed sensors, a wheel speed of one or more wheels of the vehicle.

According to an object of the present disclosure, a system for automatically applying braking during downhill motion and performing regenerative braking is provided The system may comprise a vehicle comprising a processor, an acceleration pedal, a braking pedal, and a brake controller. The processor may be configured to determine a state of the acceleration pedal and a state of the braking pedal, when the state of the acceleration pedal is off and the state of the braking pedal is off, set a set velocity of the vehicle to be equal to a current velocity of the vehicle, determine whether a value of the current velocity of the vehicle minus the set velocity of the vehicle is greater than a threshold velocity of the vehicle, when the value of the current velocity of the vehicle minus the set velocity of the vehicle is greater than the threshold velocity of the vehicle, set a target velocity of the vehicle equal to a sum of the set velocity of the vehicle and the threshold velocity of the vehicle, and perform, using a brake controller, regenerative braking on the vehicle using a DOB structure and a feedback controller to maintain the target velocity of the vehicle.

According to an exemplary embodiment, the vehicle may comprise one or more of the following: an acceleration pedal position sensor; and a braking pedal position sensor.

According to an exemplary embodiment, the determining the state of the acceleration pedal and the state of the braking pedal may comprise at least one of the following: receiving, from the acceleration pedal position sensor, the state of the acceleration pedal; and receiving, from the braking pedal position sensor, the state of the braking pedal.

According to an exemplary embodiment, the performing regenerative braking on the vehicle using the DOB structure and a feedback controller may comprise, using a regenerative braking torque calculator, calculating a regenerative braking torque, and applying the regenerative braking torque on the vehicle.

According to an exemplary embodiment, the vehicle may comprise one or more wheels and one or more wheel speed sensors. According to an exemplary embodiment, the performing regenerative braking on the vehicle using the DOB structure and a feedback controller may comprises monitoring, using the one or more wheel speed sensors, a wheel speed of the one or more wheels of the vehicle.

According to an exemplary embodiment, the processor may be further configured to, when the value of the current velocity of the vehicle minus the set velocity of the vehicle is not greater than the threshold velocity of the vehicle, perform, using the brake controller, regenerative braking on the vehicle using the DOB structure to maintain a velocity of the vehicle.

According to an exemplary embodiment, the performing regenerative braking on the vehicle using the DOB structure may comprise, using a regenerative braking torque calculator, calculating a regenerative braking torque, and applying, using the brake controller, the regenerative braking torque on the vehicle.

According to an exemplary embodiment, the vehicle may comprise one or more wheels and one or more wheel speed sensors. According to an exemplary embodiment, the performing regenerative braking on the vehicle using the DOB structure may comprise monitoring, using the one or more wheel speed sensors, a wheel speed of the one or more wheels of the vehicle.

According to an object of the present disclosure, a system for automatically applying braking during downhill motion and performing regenerative braking is provided. The system may comprise a vehicle comprising an acceleration pedal, a braking pedal, and a brake controller, and a computing device, comprising a processor and a memory, configured to store programming instructions. The programming instructions, when executed by the processor, may be configured to cause the processor to determine a state of the acceleration pedal and a state of the braking pedal, when the state of the acceleration pedal is off and the state of the braking pedal is off, set a set velocity of the vehicle to be equal to a current velocity of the vehicle, determine whether a value of the current velocity of the vehicle minus the set velocity of the vehicle is greater than a threshold velocity of the vehicle, when the value of the current velocity of the vehicle minus the set velocity of the vehicle is greater than the threshold velocity of the vehicle, set a target velocity of the vehicle equal to a sum of the set velocity of the vehicle and the threshold velocity of the vehicle, and perform, using a brake controller, regenerative braking on the vehicle using a DOB structure and a feedback controller to maintain the target velocity of the vehicle.

According to an exemplary embodiment, the vehicle may comprise one or more of the following: an acceleration pedal position sensor; and a braking pedal position sensor. According to an exemplary embodiment, the determining the state of the acceleration pedal and the state of the braking pedal may comprise at least one of the following: receiving, from the acceleration pedal position sensor, the state of the acceleration pedal; and receiving, from the braking pedal position sensor, the state of the braking pedal.

According to an exemplary embodiment, the performing regenerative braking on the vehicle using the DOB structure and a feedback controller may comprise, using a regenerative braking torque calculator, calculating a regenerative braking torque, and applying the regenerative braking torque on the vehicle.

According to an exemplary embodiment, the vehicle may comprise one or more wheels and one or more wheel speed sensors. According to an exemplary embodiment, the performing regenerative braking on the vehicle using the DOB structure and a feedback controller may comprise monitoring, using the one or more wheel speed sensors, a wheel speed of the one or more wheels of the vehicle.

According to an exemplary embodiment, the programming instructions, when executed, may further be configured to cause the processor to, when the value of the current velocity of the vehicle minus the set velocity of the vehicle is not greater than the threshold velocity of the vehicle, perform, using the brake controller, regenerative braking on the vehicle using the DOB structure to maintain a velocity of the vehicle.

According to an exemplary embodiment, the performing regenerative braking on the vehicle using the DOB structure may comprise, using a regenerative braking torque calculator, calculating a regenerative braking torque, and applying, using the brake controller, the regenerative braking torque on the vehicle.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle configured to automatically apply braking during downhill motion and perform regenerative braking, according to an exemplary embodiment of the present disclosure.

FIG. 2 illustrates a system for calculating regenerative braking torque, according to an exemplary embodiment of the present disclosure.

FIG. 3 illustrates a flowchart of a method for automatically applying braking during downhill motion and performing regenerative braking, according to an exemplary embodiment of the present disclosure.

FIG. 4 illustrates example elements of a computing device, according to an exemplary embodiment of the present disclosure.

FIG. 5 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors, multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

When electric and other such echo-friendly vehicles coast (i.e., when a vehicle is driven by inertia without an accelerator pedal and a brake pedal depressed), regenerative braking that operates a motor as a power generator to charge a battery by collecting inertia energy may be performed. That is, motor torque may be controlled into regenerative braking torque (referred to as coast regen torque) that is torque having a negative magnitude when such echo-friendly vehicles coast, whereby a battery may be charged through the collection of inertia energy.

When an electric vehicle is traveling downhill, the electric vehicle accelerates, unnecessarily, requiring the attention of a driver to control the speed of the electric vehicle. According to an exemplary embodiment, systems and methods are provided for automatically controlling the speed of an electric vehicle (or other suitable vehicle). According to an exemplary embodiment, the automatic speed control comprises performing regenerative braking, recuperating energy from the unnecessary acceleration, reducing necessary driver brake pedal action, recharging the batteries of the electric vehicle, and improving the driving experience of the driver of the electric vehicle.

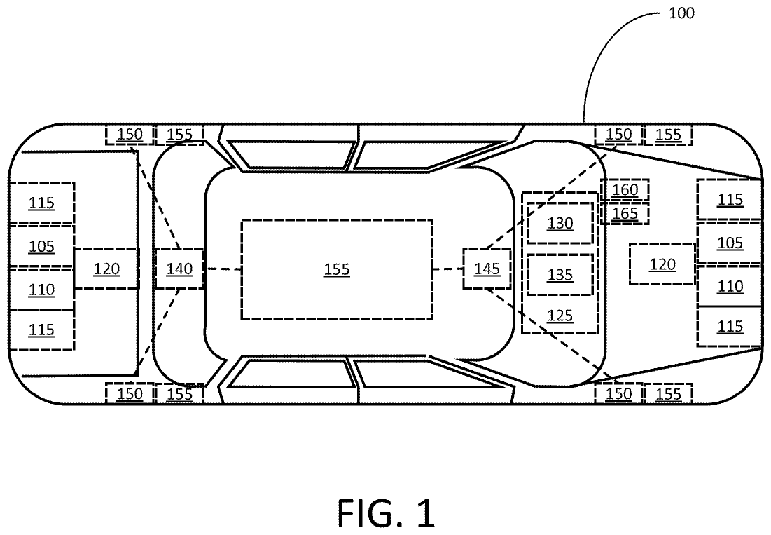

Referring now to FIG. 1, a vehicle 100 configured to automatically apply braking during downhill motion and perform regenerative braking is illustratively depicted, in accordance with an exemplary embodiment of the present disclosure.

According to an exemplary embodiment, the systems and methods of the present disclosure regulate vehicle speed using regenerative braking by monitoring the vehicle speed without an accelerometer or slope sensor when descending a hill while normal driving (e.g., when cruise control is not activated), using a disturbance observer (DOB) and a feedback controller.

According to an exemplary embodiment, the vehicle 100 may comprise one or more sensors such as, for example, one or more LiDAR sensors 105, one or more radio detection and ranging (RADAR) sensors 110, one or more cameras 115, and/or one or more position determining sensors 120 (e.g., one or more Global Positioning System devices), among other suitable sensors. According to an exemplary embodiment, the one or more sensors may be in electronic communication with one or more computing devices 125. The one or more computing devices 125 may be separate from the one or more sensors and/or may be incorporated into the one or more sensors.

According to an exemplary embodiment, the vehicle 100 may comprise one or more motor generators 140, 145. The one or more motor generators 140, 145 may be configured to be operated as power generators and may be configured to perform a function of a power generator during regenerative braking during the brake functions of one or more braking mechanisms 150.

According to an exemplary embodiment, the one or more motor generators 140, 145, in conjunction with the one or more braking mechanisms 150, may be configured to perform regenerative braking that operates the one or more motor generators 140, 145 as a power generator to charge one or more batteries 155 by collecting inertia energy.

According to an exemplary embodiment, the DOB structure may be configured to distinguish unknown external disturbances and unmodeled dynamics from nominal vehicle behavior by treating unknown external disturbances and unmodeled dynamics as disturbances. Assuming nominal vehicle behavior is defined as a case in which the vehicle travels along a flat road, the DOB may be configured to capture the different behavior between the current status and the nominal model. Using the difference, the DOB structure may be configured to determine whether a desired regenerative motor torque command to suppress the disturbances is needed and make the vehicle behave like the nominal model. According to an exemplary embodiment, when the difference is bigger than the predetermined offset from a driver, a feedback controller, based on the nominal model, may be configured to kick in to maintain the target speed.

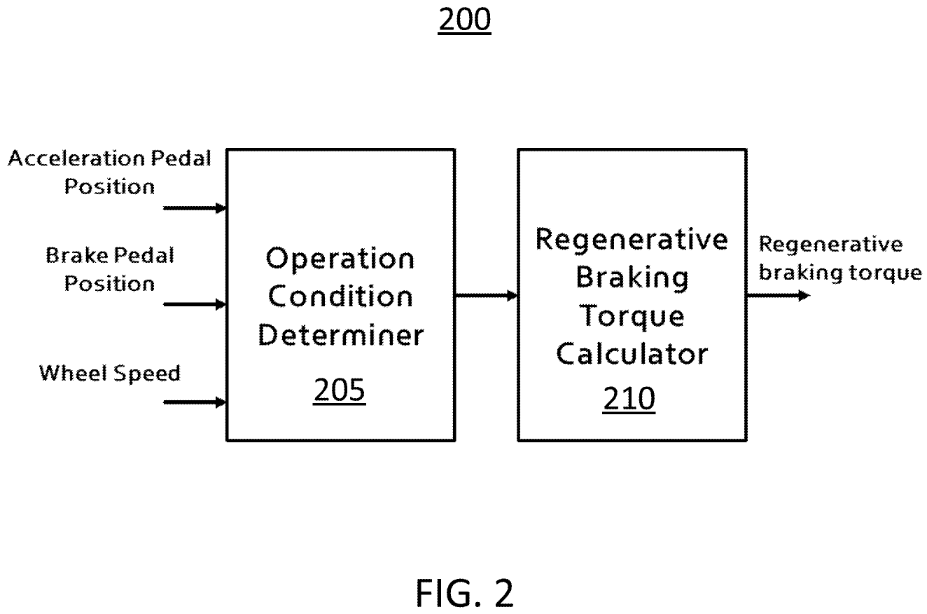

According to an exemplary embodiment, the vehicle 100 may comprise a system 200 for calculating regenerative braking torque, as shown, e.g., in FIG. 2.

According to an exemplary embodiment, the system 200 for calculating regenerative braking torque may comprise an operation condition determiner 205 configured to receive and determine an acceleration pedal position (e.g., from an acceleration pedal position sensor 160), a braking pedal position (e g., from a braking pedal position sensor 165), a wheel speed, and/or other suitable conditions and/or measurements. According to an exemplary embodiment, the operation condition determiner 205 may be configured to determine whether one or more conditions have been met for regenerative braking torque to be calculated. According to an exemplary embodiment, the vehicle 100 may comprise one or more wheel speed sensors 155 configured to measure a wheel speed of one or more wheels of the vehicle 100.

The system 200 for calculating regenerative braking torque may comprise a regenerative braking torque calculator 210. According to an exemplary embodiment, upon determining that the one or more conditions have been met for regenerative braking torque to be calculated, the regenerative braking torque calculator 210 may be configured to calculate and/or output a regenerative braking torque.

According to an exemplary embodiment, the operation condition determiner 205 and/or the regenerative braking torque calculator 210 may be components of, comprised within, and/or in electronic communication with computing device 125.

According to an exemplary embodiment, the computing device 125 may comprise a processor 130 and/or a memory 135. The memory 135 may be configured to store programming instructions that, when executed by the processor 130, may be configured to cause the processor 130 to perform one or more tasks such as, e.g., determining whether one or more conditions (e.g., a condition of an acceleration pedal, a condition of a braking pedal, a condition of a wheel speed, etc.) have been met for regenerative braking torque to be calculated, calculating the regenerative braking torque, outputting the regenerative braking torque, determining one or more vehicle actions (e.g., generating and/or implementing one or more commands to suppress disturbances and make the vehicle behave like a nominal model, etc.), and/or performing one or more vehicle actions (e.g., applying generative braking, adjusting a speed of the vehicle, etc.), among other functions.

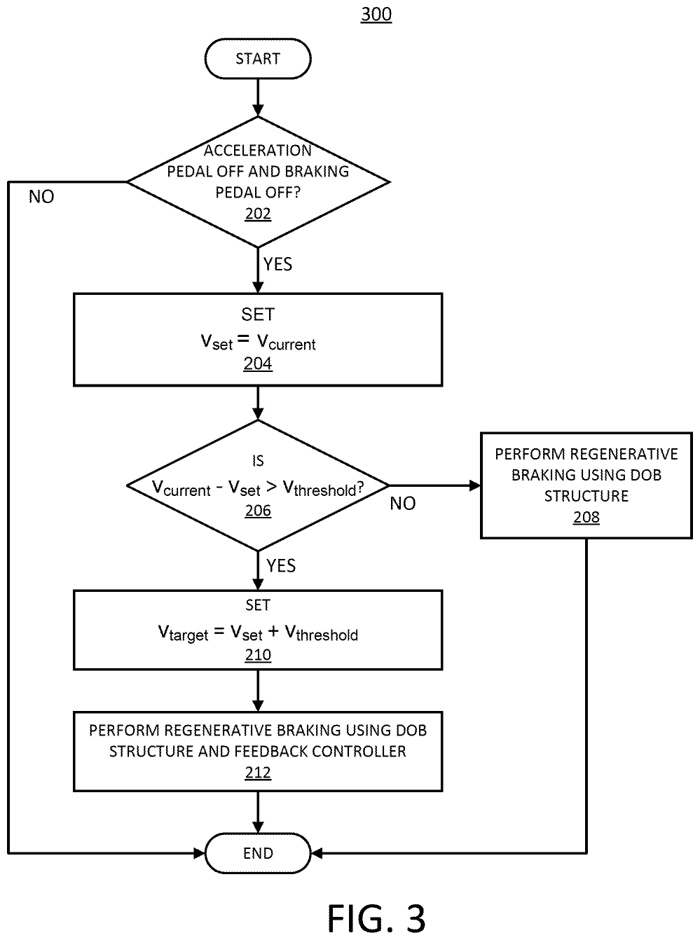

Referring now to FIG. 3, a flowchart of a method 300 for automatically applying braking during downhill motion and performing regenerative braking is illustratively depicted, according to an exemplary embodiment of the present disclosure.

At 302, it is determined, using an operation condition determiner, whether an acceleration pedal of a vehicle is off and whether a braking pedal of the vehicle is off. According to an exemplary embodiment, determining whether the acceleration pedal and braking pedal of the vehicle are off may comprise receiving, from one or more sensors (e.g., an acceleration pedal position sensor, a braking pedal position sensor, and/or other suitable sensor), a state of the acceleration pedal (e.g., on, off, etc.) and a state of the braking pedal (e.g., on, off, etc.). According to an exemplary embodiment, when either the acceleration pedal or the braking pedal of the vehicle is not off, the method ends.

According to an exemplary embodiment, when both the acceleration pedal and the braking pedal of the vehicle are off, then, at 304, a set vehicle velocity, vₛₑₜ is set as equal to a current vehicle velocity, v_{current}. At 306, it is determined whether the current vehicle velocity, v_{current}, minus the set vehicle velocity, vₛₑₜ, is greater than a threshold change in velocity, v_{threshold}.

According to an exemplary embodiment, when the current vehicle velocity, v_{current}, minus the set vehicle velocity, vₛₑₜ, is not greater than a threshold change in velocity, v_{threshold}, then, at 308, regenerative braking may be performed (via, e.g., a brake controller) using the DOB structure wherein, assuming a vehicle nominal vehicle behavior is defined as a case where the vehicle travels along a flat road, the DOB structure may be configured to capture the different behavior between the current status and the nominal model and, using the difference, the DOB structure may be configured to determine a desired regenerative motor torque command to suppress the disturbances and make the vehicle behave like the nominal model. According to an exemplary embodiment, performing regenerative braking may comprise monitoring a wheel speed (via, e.g., one or more wheel speed sensors) of one or more wheels of the vehicle.

According to an exemplary embodiment, using the DOB structure, assuming a wheel speed sensor on each wheel is available, the vehicle speed may be calculated using the combination of wheel speed information.

The DOB structure may be used as a control method to estimate external disturbance and system uncertainties. By designing the nominal system model as the dynamics to consider, the DOB structure may be configured to differentiate unmodeled dynamics effects (d_{unknown}) (in this case, the downhill slope) from the nominal model.

According to an exemplary embodiment, the DOB structure may be configured to make the vehicle behave like a defined nominal model, which may be defined when the vehicle travels on a flat road. Therefore, the vehicle, using the DOB structure, may not accelerate as much as when the vehicle is travelling downhill without an accelerometer or slope sensor.

By defining the effect caused by the road slope as an unknown disturbance term, the DOB structure may be configured to estimate the unknown disturbance term to suppress it without an accelerometer or slope sensor.

According to an exemplary embodiment, from longitudinal dynamics, the equations of motion may be formulated according to Equation 1.

$${m}_{eq} \dot{v} = {F}_{m} + {F}_{Drag} + {F}_{Rolling} + {F}_{Gradient} \qquad Equation 1$$

$$where :$$

$${F}_{m} = \frac{{T}_{m} N}{r}$$

$${F}_{Drag} = \frac{1}{2} ρ {C}_{drag} {Av}^{2}$$

$${F}_{Rolling} = {m}_{eq} μ g cos θ = {m}_{eq} μ g ( 1 + Δ )$$

$${F}_{Gradient} = {m}_{eq} μ g sin θ$$

$$and :$$

$$x = v and u = {F}_{m}$$

$${d}_{known} = {F}_{Drag} + {m}_{eq} μ g$$

$${d}_{unknown} = {m}_{eq} μ g Δ + {F}_{Gradient}$$

According to an exemplary embodiment, when the current vehicle velocity, v_{current}, minus the set vehicle velocity, vₛₑₜ, is greater than a threshold change in velocity, v_{threshold}, then, at 310, a target vehicle velocity, v_{target}, may be set as equal to a sum of the set vehicle velocity, vₛₑₜ, and the threshold change in velocity, v_{threshold}, and, at 312, regenerative braking may be performed (via, e.g., a brake controller) using the DOB structure and a feedback controller to maintain the target vehicle velocity, v_{target}. According to an exemplary embodiment, performing regenerative braking may comprise monitoring a wheel speed (via, e.g., one or more wheel speed sensors) of one or more wheels of the vehicle.

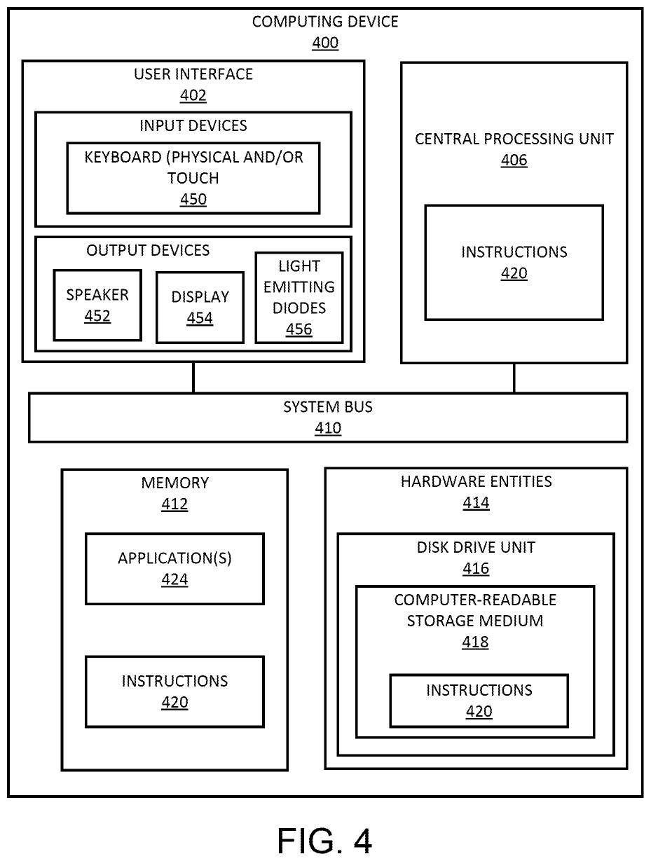

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400.

The hardware architecture of FIG. 4 represents one example implementation of a representative computing device configured to perform one or more methods and means for automatically applying braking during downhill motion and performing regenerative braking, as described herein. As such, the computing device 400 of FIG. 4 may be configured to implement at least a portion of the method(s) described herein (e.g., method 300 of FIG. 3) and/or implement at least a portion of the functions of the system(s) described herein (e.g., vehicle 100 of FIG. 1).

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the computing device 400 and that cause the computing device 400 to perform any one or more of the methodologies of the present disclosure.

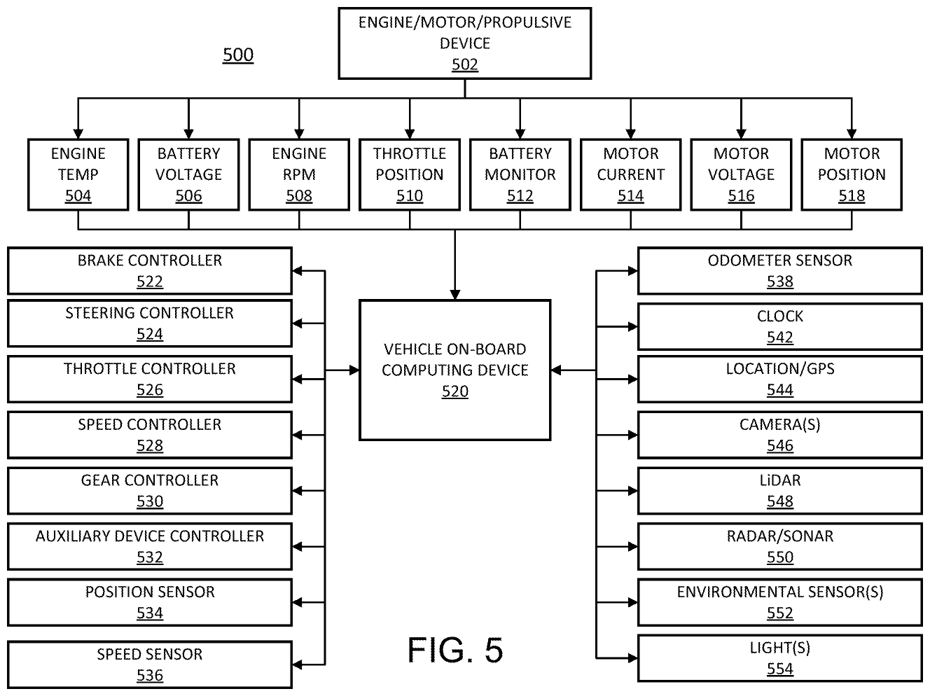

Referring now to FIG. 5, an example vehicle system architecture 500 for a vehicle is provided, in accordance with an exemplary embodiment of the present disclosure.

Vehicle 100 may be configured to be incorporated in or with a vehicle having the same or similar system architecture as that shown in FIG. 5. Thus, the following discussion of vehicle system architecture 500 is sufficient for understanding one or more components of vehicle 100.

As shown in FIG. 5, the vehicle system architecture 500 may comprise an engine, motor or propulsive device (e.g., a thruster) 502 and various sensors 504-518 for measuring various parameters of the vehicle system architecture 500. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example: a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 also may comprise various sensors that operate to gather information about the environment in which the vehicle is traveling. These sensors may comprise, for example: a location sensor 544 (for example, a Global Positioning System (GPS) device); object detection sensors such as one or more cameras 546; a LIDAR sensor system 548; and/or a RADAR and/or a sonar system 550. The sensors also may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel. According to an exemplary embodiment, the vehicle system architecture 500 may comprise one or more lights 554 (e.g., headlights, flood lights, flashlights, etc.).

During operations, information may be communicated from the sensors to an on-board computing device 520 (e.g., computing device 400 of FIG. 4). The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions), and/or other controllers. The brake controller 522 may comprise a pedal effort sensor, pedal effort sensor, and/or simulator temperature sensor, as described herein.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LiDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for automatically applying braking during downhill motion and performing regenerative braking, comprising:
a) determining a state of an acceleration pedal of a vehicle and a state of a braking pedal of the vehicle;
b) when the state of the acceleration pedal is off and the state of the braking pedal is off, setting, using a processor, a set velocity of the vehicle to be equal to a current velocity of the vehicle;
c) determining, using the processor, whether a value of the current velocity of the vehicle minus the set velocity of the vehicle is greater than a threshold velocity of the vehicle;
d) when the value of the current velocity of the vehicle minus the set velocity of the vehicle is greater than the threshold velocity of the vehicle, setting, using the processor, a target velocity of the vehicle equal to a sum of the set velocity of the vehicle and the threshold velocity of the vehicle; and
e) performing, using a brake controller, regenerative braking on the vehicle using a disturbance observer (DOB) structure and a feedback controller to maintain the target velocity of the vehicle.

2. The method of claim 1, wherein the determining the state of the acceleration pedal and the state of the braking pedal comprises at least one of the following:
receiving, from an acceleration pedal position sensor, the state of the acceleration pedal; and
receiving, from a braking pedal position sensor, the state of the braking pedal.

3. The method of claim 1, wherein the performing regenerative braking on the vehicle using the DOB structure and a feedback controller comprises:
using a regenerative braking torque calculator, calculating a regenerative braking torque; and
applying the regenerative braking torque on the vehicle.

4. The method of claim 1, wherein the performing regenerative braking on the vehicle using the DOB structure and a feedback controller comprises:
monitoring, using one or more wheel speed sensors, a wheel speed of one or more wheels of the vehicle.

5. The method of claim 1, further comprising, when the value of the current velocity of the vehicle minus the set velocity of the vehicle is not greater than the threshold velocity of the vehicle, performing, using the brake controller, regenerative braking on the vehicle using the DOB structure to maintain a velocity of the vehicle.

6. The method of claim 5, wherein the performing regenerative braking on the vehicle using the DOB structure comprises:
using a regenerative braking torque calculator, calculating a regenerative braking torque; and
applying, using the brake controller, the regenerative braking torque on the vehicle.

7. The method of claim 5, wherein the performing regenerative braking on the vehicle using the DOB structure comprises:
monitoring, using one or more wheel speed sensors, a wheel speed of one or more wheels of the vehicle.

8. A system for automatically applying braking during downhill motion and performing regenerative braking, comprising:
a vehicle comprising:
a processor;
an acceleration pedal;
a braking pedal; and
a brake controller,
wherein the processor is configured to:
determine a state of the acceleration pedal and a state of the braking pedal;
when the state of the acceleration pedal is off and the state of the braking pedal is off, set a set velocity of the vehicle to be equal to a current velocity of the vehicle;
determine whether a value of the current velocity of the vehicle minus the set velocity of the vehicle is greater than a threshold velocity of the vehicle;
when the value of the current velocity of the vehicle minus the set velocity of the vehicle is greater than the threshold velocity of the vehicle, set a target velocity of the vehicle equal to a sum of the set velocity of the vehicle and the threshold velocity of the vehicle; and
perform, using a brake controller, regenerative braking on the vehicle using a disturbance observer (DOB) structure and a feedback controller to maintain the target velocity of the vehicle.

9. The system of claim 8, wherein:
the vehicle comprises one or more of the following:
an acceleration pedal position sensor; and
a braking pedal position sensor, and
the determining the state of the acceleration pedal and the state of the braking pedal comprises at least one of the following:
receiving, from the acceleration pedal position sensor, the state of the acceleration pedal; and
receiving, from the braking pedal position sensor, the state of the braking pedal.

10. The system of claim 8, wherein the performing regenerative braking on the vehicle using the DOB structure and a feedback controller comprises:
using a regenerative braking torque calculator, calculating a regenerative braking torque; and
applying the regenerative braking torque on the vehicle.

11. The system of claim 8, wherein:
the vehicle comprises:
one or more wheels; and
one or more wheel speed sensors, and
the performing regenerative braking on the vehicle using the DOB structure and a feedback controller comprises:
monitoring, using the one or more wheel speed sensors, a wheel speed of the one or more wheels of the vehicle.

12. The system of claim 8, wherein the processor is further configured to:
when the value of the current velocity of the vehicle minus the set velocity of the vehicle is not greater than the threshold velocity of the vehicle, perform, using the brake controller, regenerative braking on the vehicle using the DOB structure to maintain a velocity of the vehicle.

13. The system of claim 12, wherein the performing regenerative braking on the vehicle using the DOB structure comprises:
using a regenerative braking torque calculator, calculating a regenerative braking torque; and
applying, using the brake controller, the regenerative braking torque on the vehicle.

14. The system of claim 12, wherein:
the vehicle comprises:
one or more wheels; and
one or more wheel speed sensors, and
the performing regenerative braking on the vehicle using the DOB structure comprises:
monitoring, using the one or more wheel speed sensors, a wheel speed of the one or more wheels of the vehicle.

15. A system for automatically applying braking during downhill motion and performing regenerative braking, comprising:
a vehicle comprising:
an acceleration pedal;
a braking pedal; and
a brake controller; and
a computing device, comprising a processor and a memory, configured to store programming instructions that, when executed by the processor, cause the processor to:
determine a state of the acceleration pedal and a state of the braking pedal;
when the state of the acceleration pedal is off and the state of the braking pedal is off, set a set velocity of the vehicle to be equal to a current velocity of the vehicle;
determine whether a value of the current velocity of the vehicle minus the set velocity of the vehicle is greater than a threshold velocity of the vehicle;
when the value of the current velocity of the vehicle minus the set velocity of the vehicle is greater than the threshold velocity of the vehicle, set a target velocity of the vehicle equal to a sum of the set velocity of the vehicle and the threshold velocity of the vehicle; and
perform, using a brake controller, regenerative braking on the vehicle using a disturbance observer (DOB) structure and a feedback controller to maintain the target velocity of the vehicle.

16. The system of claim 15, wherein:
the vehicle comprises one or more of the following:
an acceleration pedal position sensor; and
a braking pedal position sensor, and
the determining the state of the acceleration pedal and the state of the braking pedal comprises at least one of the following:
receiving, from the acceleration pedal position sensor, the state of the acceleration pedal; and
receiving, from the braking pedal position sensor, the state of the braking pedal.

17. The system of claim 15, wherein the performing regenerative braking on the vehicle using the DOB structure and a feedback controller comprises:
using a regenerative braking torque calculator, calculating a regenerative braking torque; and
applying the regenerative braking torque on the vehicle.

18. The system of claim 15, wherein:
the vehicle comprises:
one or more wheels; and
one or more wheel speed sensors, and
the performing regenerative braking on the vehicle using the DOB structure and a feedback controller comprises:
monitoring, using the one or more wheel speed sensors, a wheel speed of the one or more wheels of the vehicle.

19. The system of claim 15, wherein the programming instructions, when executed, are further configured to cause the processor to:
when the value of the current velocity of the vehicle minus the set velocity of the vehicle is not greater than the threshold velocity of the vehicle, perform, using the brake controller, regenerative braking on the vehicle using the DOB structure to maintain a velocity of the vehicle.

20. The system of claim 19, wherein the performing regenerative braking on the vehicle using the DOB structure comprises:
using a regenerative braking torque calculator, calculating a regenerative braking torque; and
applying, using the brake controller, the regenerative braking torque on the vehicle.
